(19) United States
(12) Patent Application Publication
(10) Pub. No.: US 2010/0081415 A1
(43) Pub. Date: Apr. 1, 2010

(54) METHODS AND ARRANGEMENT FOR SUPPORTING MULTIPLE CALLS WITH A SINGLE CARRIER CONNECTION

(76) Inventors: Prashant Chauhan, Sunnyvale, CA (US); Marc Solsona-Palomar, San Jose, CA (US); Athuluru Tirumala Rao, San Francisco, CA (US)

Correspondence Address: IPSG, P.C., P.O. BOX 700640, SAN JOSE, CA, 95170, US

(21) Appl. No.: 12/240,780

(22) Filed: Sep. 29, 2008

(51) Int. Cl. H04L 12/58; H04W 4/00

(52) U.S. Cl. 455/412.1; 455/422.1

(57) ABSTRACT

A method for enabling a first telecommunication device to conduct multiple simultaneous telecommunication sessions through a single carrier connection is provided. A first telecommunication session, which includes a first carrier connection between the first telecommunication device and the mobility server and a second carrier connection between the second telecommunication device and the mobility server, is established. Also, a mid-call signaling channel is established to handle interaction between the mobility server and the first telecommunication device while the first telecommunication device is connected through the first carrier connection. The mid-call signaling channel is also employed to notify the first telecommunication device of an incoming telecommunication session request from a third telecommunication device. The method also includes establishing a second telecommunication session, which includes the first carrier connection between the first telecommunication device and the mobility server and a third carrier connection between the third telecommunication device and the mobility server.

### CROSS REFERENCE TO RELATED APPLICATIONS

The present invention is related to the following applications, all of which are incorporated herein by reference:

Commonly assigned application entitled “Enterprise-Managed Wireless Communication,” by Karia et al., Attorney Docket Number DyTS-P001, application Ser. No. 11/538,042 filed on Oct. 2, 2006.

### BACKGROUND OF THE INVENTION

Communication has long been an integral part that defines the fabric of society. Telecommunication devices (e.g., telephones, cellular telephone, smart devices, internet telephone, and the like) have become important tools in facilitating communication. With the usage of telecommunication devices, people geographically separated are able to stay in touch with one another.

To facilitate discussion, FIG. 1 shows a simple block diagram of a telecommunication arrangement. FIG. 1 is discussed in relation to FIG. 2, which is a simple call flow illustrating the steps for establishing multiple calls. Consider the situation wherein, for example, user A wants to communicate with user C.

At a first step 202, user A may pick up a telephone to call user C. In other word, user A may employ an originating telecommunication device 102 to make a telecommunication connection with a destination telecommunication device 104. When user A enters in the destination number (e.g., telephone number), a signal is sent to a call server 106 (such as a PBX exchange). At this point, a communication channel 108 has been established between user A's telecommunication device 102 and call server 106.

At a next step 204, upon receiving the signal, call server 106 sends a signal (e.g., ring tone) to the telecommunication device associated with the destination number, which is destination telecommunication device 104 in this example.

When user C at destination telecommunication device 104 accepts the signal (e.g., pick up the telephone), at a next step 206, a response is sent back to call server 106. At this point, a communication channel 110 is established between call server 106 and telecommunication device 104 via a carrier network 112.

Upon receiving the response, call server 106 may forward the response to telecommunication device 102, at a next step 208. In other words, when user C picks up the telephone, a telecommunication session 210 is established between user A and user C via originating telecommunication devices 102 and 104, respectively.

While user A and user C is communicating with one another, user C receives another telephone call. In an example, a user B may employ a telecommunication device 116 to establish a telecommunication session with user C, at a next step 212. Again when user B enters the destination number associated with telecommunication device 104, a signal is sent to call server 106.

At a next step 214, upon receiving the signal, call server 106 may send a signal to destination telecommunication device 104. At this point, a communication channel 118 is established between call server 106 and telecommunication device 116.

When user C accepts the signal (by picking up the telephone, for example), a response is sent back to call server 106, at a next step 216. At this point another communication channel 120 is established between call server 106 and telecommunication device 104.

Upon receiving the response, call server 106 may forward the response to telecommunication device 116, at a next step 218, to establish a telecommunication session 220 between user B and user C via telecommunication devices 116 and 104, respectively.

Since user C is now in communication with users A and B, two separate telecommunication sessions have been established. Although user C is not able to communicate on more than one communication channel at any one time, user C is responsible for the cost for both telecommunication sessions even if one communication channel is idle while user C is utilizing the other communication channel. In other words, user C is now responsible for the cost associated with communication channels 110 and 120.

One reason user C is being doubly charged is partly due to the two telecommunication sessions that have been established. In order to enable user C to talk with both user A and user B, more bandwidth resource has to be utilized in order to enable two telecommunication sessions to be established. Thus, even though user C may only be able to utilize one communication channel at any one time, user C is charged for the usage of both communication channels since the carrier network could have utilized the bandwidth resource to establish a telecommunication session for another user.

In addition to the cost and resources associated with establishing the two telecommunication sessions, the ability to have two simultaneous telecommunication sessions may not always be a service that is available. In other words, a user may have to subscribe to the service. In some cases, the user may not even have the option of subscribing to the service since the carrier networks may not even make the service (i.e., multiple simultaneous telecommunication sessions) available.

### BRIEF SUMMARY OF THE INVENTION

The invention relates, in an embodiment, to a method for enabling a first telecommunication device to conduct multiple simultaneous telecommunication sessions through a single carrier connection. The method includes establishing a first telecommunication session using a mobility server between the first telecommunication device and a second telecommunication device, wherein the first telecommunication session includes a first carrier connection between the first telecommunication device and the mobility server and a second carrier connection between the second telecommunication device and the mobility server. The method also includes establishing a mid-call signaling channel between the mobility server and the first telecommunication device, wherein the mid-call signaling channel is configured for at least handling interaction between the mobility server and the first telecommunication device while the first telecommunication device is connected through the first carrier connection. The method further includes utilizing the mid-call signaling channel to notify the first telecommunication device of an incoming telecommunication session request from a third telecommunication device. The method yet also includes establishing a second telecommunication session using the mobility server between the first telecommunication device and the third telecommunication device, wherein the second telecommunication session includes the first carrier connection between the first telecommunication device and the mobility server and a third carrier connection between the third telecommunication device and the mobility server.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows a simple block diagram of a telecommunication arrangement.

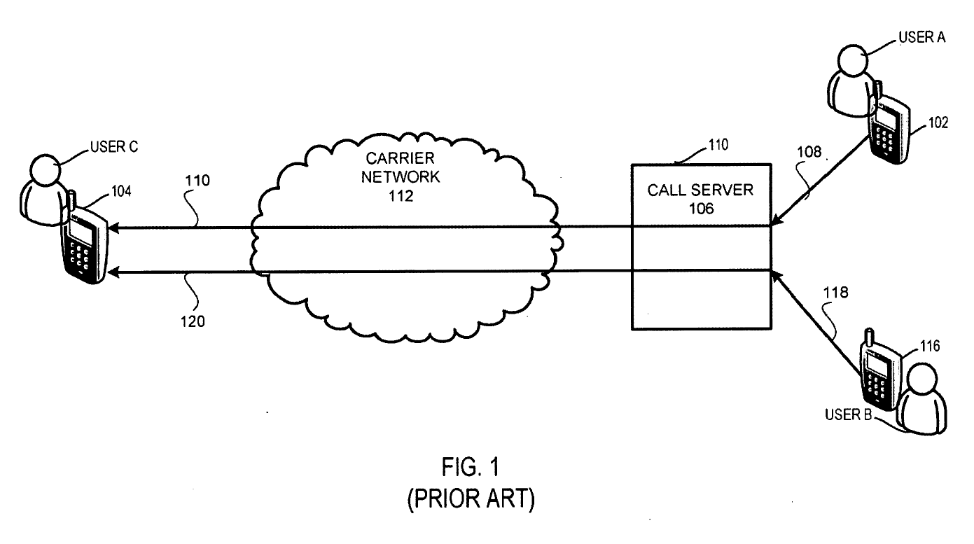

FIG. 2 shows a simple call flow of multiple telecommunication sessions.

FIG. 3 shows, in an embodiment of the invention, a simple block diagram of a telecommunication environment with a mid-call signaling channel.

FIG. 4 shows, in an embodiment of the invention, a simple call flow establishing a mid-call signaling channel.

FIG. 5 shows, in an embodiment, a simple call flow illustrating how a telecommunication session may be established between two subscribers.

FIG. 6 shows, in an embodiment of the invention, a simple architectural diagram of a mobility server and a mobility client.

FIG. 7 shows, in an embodiment of the invention, a simple diagram illustrating how a mid-call signaling channel may be employed to toggle between different telecommunication sessions.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

The inventors herein realize that once a telecommunication session has been established, additional telecommunication requests may be established with the same party using the same carrier connection (e.g., communication channel), thereby, reducing cost and resources (e.g., bandwidth resources) for establishing multiple telecommunication sessions to a single telecommunication device. In accordance with embodiments of the present invention, a method is provided for enabling multiple simultaneous telecommunication sessions through a single carrier connection. Embodiments of the invention include establishing a mid-call signaling channel for handling interaction between a mobility server and a telecommunication device, thereby enabling mobility server to manage the incoming and outgoing data traffic of the telecommunication device.

In this document, various implementations may be discussed using mobile device as an example. This invention, however, is not limited to mobile devices and may include any telecommunication devices (e.g., smart devices, internet protocol telephone, POTS telephone, and the like). Instead, the discussions are meant as examples and the invention is not limited by the examples presented.

In an embodiment of the invention, a single communication channel arrangement is provided for facilitating multiple telecommunication sessions (e.g., calls). The single communication arrangement may include a mobility server, which may be configured to manage incoming and outgoing telecommunication traffic to a mobility client. As discussed herein, a mobility client refers to a telecommunication device that includes a mobility client software that enables the mobility client to interact with the mobility server.

To facilitate interaction, the mobility client and the mobility server may include a plurality of function modules, including but are not limited to, a call control module, a mobility manager module, a mid-call control protocol module, and a media server module. With the function modules, a user of the mobility client is able to toggle between telecommunication sessions through a mid-call signaling channel in order to enable the multiple telecommunication sessions to be supported on a single carrier connection.

Unlike the prior art, multiple carrier connections for a single user are not required in order for the mobility client to be an active participant in multiple telecommunication sessions. Instead, the mobility server may manage the flow of data traffic based on commands received from the mobility client via the mid-call signaling channel.

The features and advantages of the present invention may be better understood with reference to the figures and discussions that follow.

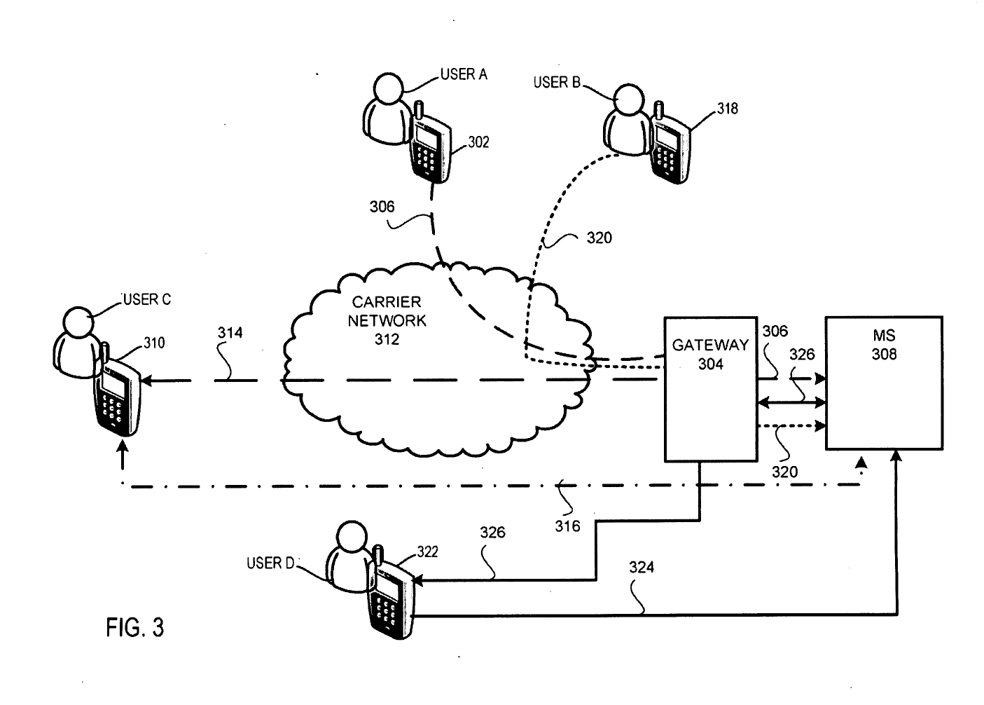

FIG. 3 shows, in an embodiment of the invention, a simple block diagram of a telecommunication environment with a mid-call signaling channel. Consider the situation wherein, for example, a user A wants to communicate with user C. The telecommunication request by user A of originating telecommunication device 302 may traverse through a carrier network 312 to connect with user C of destination telecommunication device 310. As discussed herein, a telecommunication device refers to a device that may be employed to send data packets. Examples of telecommunication devices include, but are not limited to, cellular telephones, desk telephones, multi-mode telephones, interne protocol (IP) telephones, and the like.

In this example, user C is a subscriber of a mobility service provider such as a mobility server 308. In order to be a subscriber, telecommunication device 310 may install a mobility client software that may enable telecommunication device 310 to interact with mobility server 308. Accordingly, a telecommunication device with a mobility client software may also be referred to as a mobility client. Discussion about mobility client and mobility server has been provided in a pending application (application Ser. No. 11/538,042). Components that may enable mobility client and mobility server to interact with one another to enable the different embodiments of the invention will be discussed in later figures.

As a subscriber, telecommunication device 310 may first register with mobility server 308 upon activation. Once mobility server 308 has received the registration information and has verified that the telecommunication device is a valid subscribed device, mobility server 308 is configured to handle incoming and outgoing telecommunication requests to-and-from the subscribed telecommunication device. In an example, data traffic may be routed to mobility server 308 before being forwarded to a final destination telecommunication device.

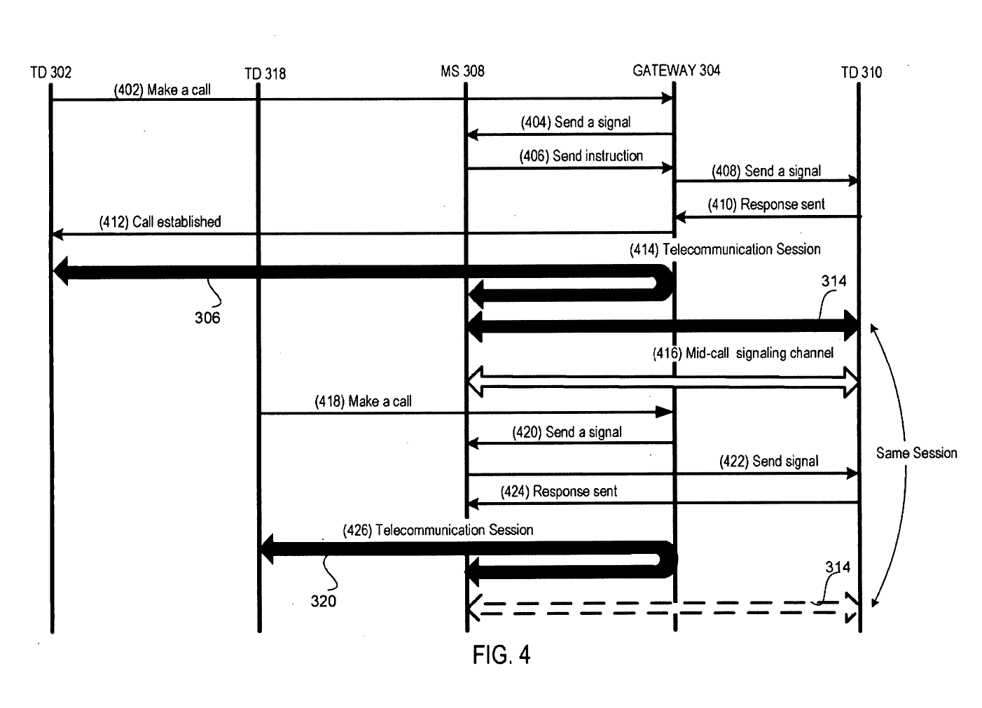

In the example above, when user A enters a destination number associated with telecommunication device 310, a signal is sent to mobility server 308 via a gateway 304 (e.g., PBX), since telecommunication device 310 is a subscriber. To illustrate how a telecommunication session may be established, FIG. 3 is discussed in relation to FIG. 4, which shows, in an embodiment of the invention, a simple call flow illustrating multiple telecommunications being handled by a single carrier connection.

At a first step 402, a signal is sent to a gateway, such as gateway 304. At this point a communication channel 306 is established between telecommunication device 302 and gateway 304.

Upon receiving the signal, gateway 304 may forward the signal to a mobility server 308, at a next step 404, since user C is a subscribed user of mobility server 308. As aforementioned, mobility server is configured to handle its subscriber's incoming and outgoing calls. In other words, mobility server 308 may act as a “traffic cop” directing the incoming and outgoing calls to its subscribers. In an example, mobility server 308 may check to determine the best medium for establishing a connection with the destination telecommunication device. In other words, even though the destination telecommunication device is a cellular telephone, the destination telecommunication device may be close to a Wi-Fi hotspot. Thus, the best and least inexpensive medium for establishing a communication channel with user C via telecommunication device 310 may be through a Wi-Fi network instead of through a cellular network.

Once mobility server 308 has made a determination about the status of destination telecommunication device 310, at a next step 406, mobility server 308 may send a signal to gateway 304 with instruction on how to establish the communication channel with destination telecommunication device 310.

At a next step 408, gateway 304 may send a signal (e.g., ring tone) to telecommunication device 310.

When telecommunication device 310 receives the signal, user C may accept the signal (by picking up the telephone, for example) and send a response back to gateway 304, at a next step 410. At this point, a communication channel 314 between gateway 304 and telecommunication device 310 has been established.

At a next step 412, gateway 304 may forward the response to telecommunication device 302, thereby establishing a telecommunication session 414 (as shown by communication channels 306 and 314) between originating telecommunication device 302 and destination telecommunication device 310.

In an embodiment, at a next step 416, mobility server 308 may established a mid-call signaling channel 316 with telecommunication device 310. As discussed herein, a mid-call signaling channel refers to a sub-channel that is created from a communication channel 314 that may exist between telecommunication device 310 and mobility server 308 via gateway 304. Mid-call signaling channel 316 may be established to enable mobility server 304 and telecommunication device 310 to interact with one another during a telecommunication session. In other words, as long as communication channel 314 is active, mid-call signaling channel 316 may be maintained to enable mobility server 308 to communicate with telecommunication device 310.

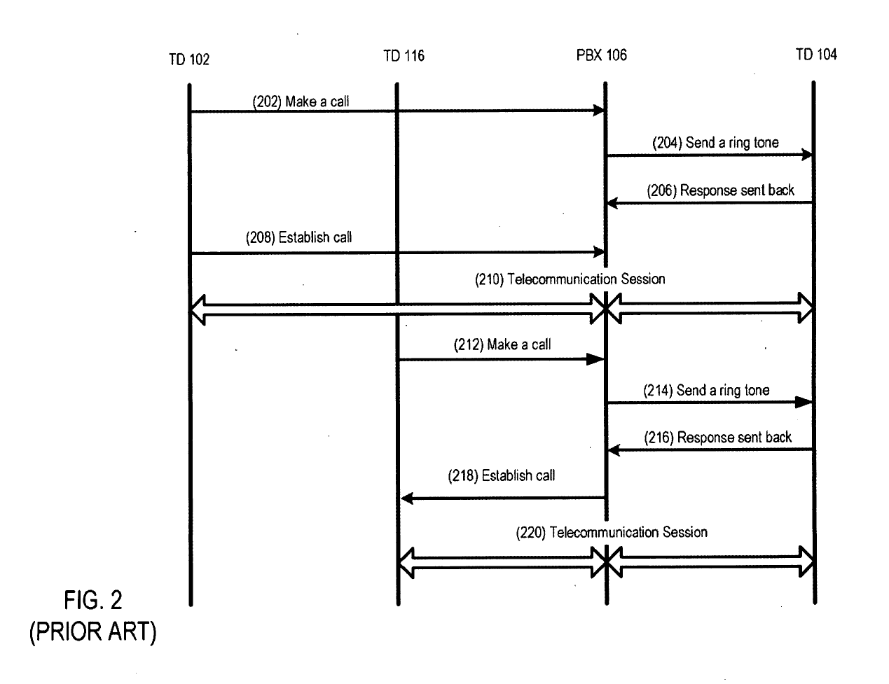

Similar to the prior art, the telecommunication session that has been established between user A's telecommunication device 302 and user C's telecommunication device 310 may require about the same amount of resources (e.g., bandwidth) to enable the two users to communicate with one another. In an example, the bandwidth usage for establishing telecommunication session 414 is similar to that of telecommunication session 210 of prior art FIG. 2. However, unlike the prior art, the setup of a second telecommunication session does not require establishing another communication channel with the same user (e.g., user C). Consider the situation wherein, for example, a user B makes a call to user C while user C is communicating with user A.

At a next step 418, a signal is sent to the gateway, such as gateway 304. In an example, user B may employ a telecommunication device 318 to communicate With user C at telecommunication device 310. When the destination number is entered, a signal is sent from telecommunication device 318 through carrier network 312 to be received by gateway 304. When gateway 304 receives the signal, a communication channel 320 is established between telecommunication device 318 and gateway 304.

Similar to step 404, upon receiving the signal, gateway 304 may forward the signal to a mobility server 308, at a next step 420. Since user C is a subscribed user of mobility server 308, mobility server 308 may check the status of user C's telecommunication device. In this example, mobility server may identify that a communication channel may already exist between mobility server, via gateway 304, and telecommunication device 310.

Accordingly, instead of instructing gateway 304 to establish another communication channel with telecommunication device 310, mobility server 308 may send a signal (e.g., ring tone) to telecommunication device via mid-call signaling channel 316 to alert user C of telecommunication device 310 of a second incoming telecommunication request, at a next step 422. Thus, instead of expending carrier resources on establishing another communication channel between telecommunication device 310 and mobility server 308 via gateway 304, the same communication channel 314 may be employed to establish a telecommunication session between user B's telecommunication device 318 and user C's telecommunication device 310 (once user C accepts the call, at a next step 424). In other word, the first telecommunication session (414) and the second telecommunication session (426) shares the same communication channel 314 when handling data packets to-and-from telecommunication device 310. Discussion on how mobility server 308 is configured to handle data packets coming from a plurality of telecommunication devices, for example, will be provided in later figures.

As can be appreciated from the foregoing, by reusing the same communication channel (314), less carrier resources may have to be utilized. Thus, the carrier is able to establish more telecommunication sessions. Also, since another communication channel has not been established for telecommunication device 310, user C is not charged an additional cost for participating in multiple simultaneous telecommunication sessions.

Further, in the prior art, the number of simultaneous calls that a user may participate in may be limited by the carrier ability to provide the service. Thus, even if a user may want to subscribe to the service, the user may not have the option since the carrier may not provide the service. With the embodiment described above, a user is not required to subscribe to the service and the user is also not dependent upon the carrier to provide the service.

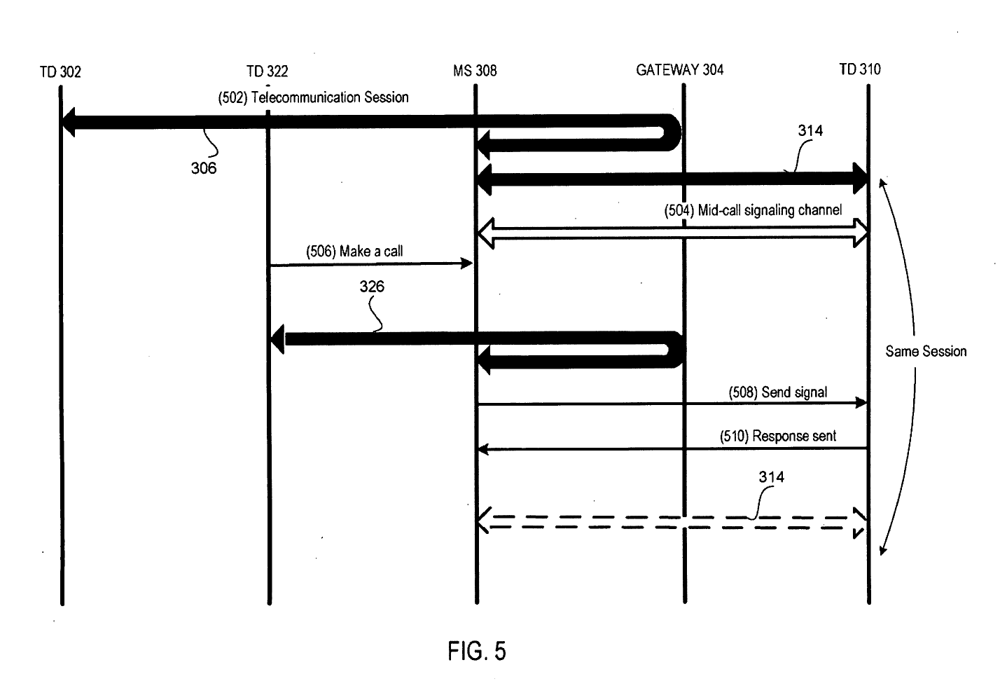

FIG. 4 above illustrates an example of a call flow between a subscriber (user C) and non-subscribers (users A and B). A similar type of call may exist between two subscribers. FIG. 5 shows, in an embodiment, a simple call flow illustrating how a telecommunication session may be established between two subscribers. FIG. 5 will be discussed in relation to FIG. 3.

Consider the situation wherein, for example user A and user C are currently communicating with one another. In other words, a telecommunication session 502 (communication channels 306 and 314) has been established between user A's telecommunication device 302 and user C's telecommunication device 310. In addition, a mid-call signaling channel 504 (316) has been established between mobility server 308 and telecommunication device 310. While user A and user C are currently interacting with one another, user D may decide to communicate with user C. In this example, user D is also a subscriber. Since user D is a subscriber, user D's telecommunication device 322 may have already been validated by mobility server 308.

At a first step 506, a signal is sent to mobility server 308. In an example, when user D enters in the destination number associated with user C's telecommunication device 310, a signal is sent to mobility server 308, via a path 324. The signal is sent to mobility server 308 since mobility server 308 may act as the anchor point for connections established by its subscribers.

At this point, a communication channel 326 is established between user D's telecommunication device 322 and mobility server 308 via gateway 304.

Since a communication channel currently exist for telecommunication device 310, a new communication channel is not created, in an embodiment. Instead, at a next step 508, mobility server 308 may send a signal (e.g., ring tone) to telecommunication device 310 via mid-call signaling channel 316 alerting user C of an incoming call.

At a next step 510, telecommunication device 310 may send a response back after user C has accepted the call.

Thus, a second telecommunication session is created in which the same communication channel (314) is re-used to enable user C to communicate with user D.

As can be appreciated from the foregoing, the telecommunication sessions that have been established is not negatively impacted if user C roams into another network. In an example, the communication channel for user C's telecommunication device is currently being supported through a Wi-Fi network. If user C roams outside of the Wi-Fi network into a cellular network, then the mobility server may establish a communication channel with user C's telecommunication device via a cellular network first before terminating the communication channel via the Wi-Fi network. As can be appreciated from the foregoing, when the communication channel via the Wi-Fi network is disconnected, the mid-call signaling channel associated with the communication channel may also be terminated, in an embodiment. In an embodiment, another mid-call signaling channel may be established when the new communication channel (via cellular) is established in order to enable the mobility server to interact with the mobility client software of user C's telecommunication device.

As can be appreciated from FIGS. 3-5, multiple telecommunication sessions may be established with the same user without requiring additional bandwidth for communication with the user. In addition, the telecommunication sessions may be established without having to rely on a carrier network. In other words, even if a carrier network does not provide the service of establishing multiple telecommunication sessions, the mobility service provider is still able to provide its subscribers with the benefit of participating in multiple telecommunication sessions. In addition, unlike the prior art in which the carrier network may be limited by the number of simultaneous telecommunication sessions a user may participate in due to the infrastructure of the carrier network, no such limitation exists in embodiments of the invention.

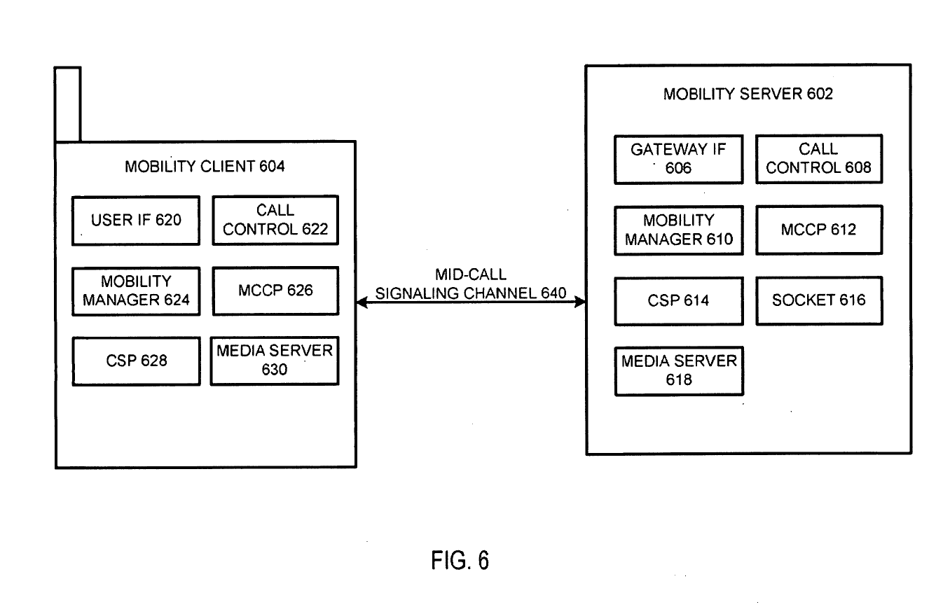

FIG. 6 shows, in an embodiment of the invention, a simple architectural diagram of a mobility server and a mobility client. A mobility server 602 may include various server functional modules that may enable mobility server 602 to interact with mobility client 604. As discussed herein, a mobility client refers to a telecommunication device with mobility client software, which enables the telecommunication device to interact with the mobility server, installed.

Examples of server functional modules may include, but are not limited to, a gateway interface 606, a call control server module 608, a mobility manager server module 610, a mid-call control protocol server module 612, a call signaling protocol (CSP) server module 614, a socket module 616, and a media server 618.

With gateway interface module 606, mobility server 602 is able to interact with a gateway, such as a PBX.

Call control server module 608 may be configured to establish data communication (e.g., voice calls or audio/video/information streaming). In an example, call control server module may be configured to perform resource and connection management.

Mobility manager server module 610 may be configured to manage connectivity information received from mobility client 604. An example of connectivity information is the signal strength received by mobility client 604. Mobility manager server module 610 may also be configured to manage roaming.

A mid-call control protocol server module 612 may be configured to enable mobility client and mobility server to interact with one another. In an example, with a mid-call control protocol server module 612, mobility server 602 may be able to utilize a single communication channel to support multiple telecommunication sessions to a single user's telecommunication device.

CSP server module 614 may be configured to perform the decoding and/or encoding of data packets traversing between mobility client 604 and mobility server 602. In an embodiment, mid-call control protocol server module 612 may be configured to handle the encoding and decoding before forwarding the packet to CSP server module 614.

Socket server module 616 may be configured to handle communication between the various modules.

Media server 618 may be configured for managing voice and data traffic. Also, media server 618 may be configured to perform encryption and decryption to ensure the secure transmission of data. Media server 618 may also include a transcoder, thereby enabling mobility server to convert data into different data format (e.g., GSM, G.711, G.729, etc.) that is acceptable by the intended telecommunication device.

Similarly, mobility client 604 may include various client functional modules. Examples of client functional modules may include, but are not limited to, a user interface module 620, a call control client module 622, a mobility manager client module 624, a mid-call control protocol client module 626, a CSP client module 628, and a client media server module 630.

With a user interface module 620, a user may be able to interact with mobility client 604. In an example, a user may enter a destination number by employing a user interface module 620. In another example, a user may receive incoming message by interacting with user interface module 620.

Similar to call control server module 608, call control client module 622 may be configured to establish data communication (e.g., voice calls or audio/video/information streaming). In an example, call control client module 622 may receive instructions from user interface module 620. Upon receiving the instructions, call control client module 622 may manage the other client functional modules to initiate the outgoing data. In other words, call control client module 622 may be configured to determine when the user of the telecommunication device wants to toggle between telecommunication sessions.

Similar to mobility manager server module 610, mobility manager client module 624 may be configured to manage connectivity information for mobility client 604.

Mid-call control protocol client module 626 may be the reciprocal protocol for mid-call control protocol server module 612. In other words, mid-call control protocol client module may allow the telecommunication device to interact with the mobility server in order to enable multiple telecommunication sessions to a single telecommunication device be supported on a single communication channel.

CSP client module 628 may be configured to decode and encode data packets traversing between mobility client 604 and mobility server 602. In an embodiment, mid-call control protocol client module 626 may be configured to handle the encoding and decoding before forwarding the packet to CSP client module 628.

Client media server module 630 may be configured to handle voice and data traffic. Further, client media server module 630 may be configured to perform encryption, echo cancellation, jitter control, error concealment, and the like.

Each of these functional modules is configured to enable mobility client 604 to interact with mobility server 602. In an embodiment, the functional components may interact with one another to establish a mid-call signaling channel 640 when a communication channel (e.g., carrier connection) is established between mobility server 602 and mobility client 604. As aforementioned, with the creation of mid-call signaling channel 640, several functions may be performed. In an example, mobility server 602 may alert mobility client 604 when another telecommunication session is being requested. In another example, mobility client 604 may inform mobility server 602 when mobility client 604 wants to receive data packets from a specific telecommunication device. In other words, a user may toggle between calls via mid-call signaling channel 640.

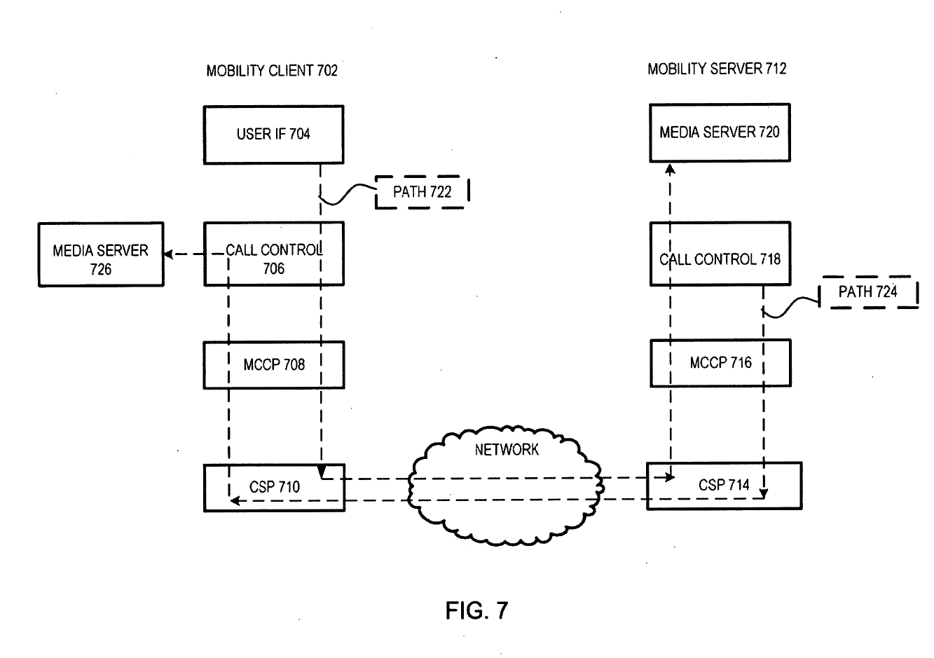

To illustrate how these various different functional modules may be implemented, FIG. 7 shows, in an embodiment of the invention, a simple diagram illustrating how a mid-call signaling channel may be employed to toggle between different telecommunication sessions. Consider the situation wherein, for example, a user C of a mobility client 702 is participating in two telecommunication sessions. In an example, user C may be arranging a trip with a travel agent for himself and his wife. The first telecommunication session is with user A (his travel agent) and the second telecommunication session is with user B (his wife). In this example, user C of mobility client 702 is currently making travel arrangement with user A (his travel agent). During the conversation, user C may need to consult with his wife (user B) to get her opinion about a tour.

To toggle between the two telecommunication sessions, user C may send a command (e.g., push a button) to perform the switch. In an example, user C may click on a soft button shown on a user interface module 704 to activate the switch. The “push” may activate a call control client module 706, which may notify mid-call control protocol client module 708 about the request. Upon receiving the message (e.g. toggle request), mid-call control protocol client module 708 may be configured to encode the message into a format that may be sent through a CSP client module 710, in an embodiment. Once the message has been encoded, the message may be sent as a CSP notify message (e.g., network-enabled format) through CSP client module 710 via a network (e.g., internet) to a mobility server 712.

At mobility server 712, the CSP notify message may be received by a CSP server module 714. Upon receiving the CSP notify message, CSP server module 714 may forward the message to a mid-call control protocol server module 716, which may be configured to decode the message. Once the message has been decoded, the message may be passed to a call control server module 718. Upon receiving the message, call control server module 718 may be configured to notify a media server module 720 along a path 722 about user C's request. Media server module 720 upon receiving the message may be configured to perform the switch. In other words, media server module 720 may allow data packets being received from user B's telecommunication device to be forwarded to user C's telecommunication device. At the same time, media server module 720 may prevent data packets received from user A's telecommunication server to be sent to user C's telecommunication device.

In an embodiment, after sending the message to media server module 720, call control server module 718 may send a message (i.e., confirmation) to mid-call control protocol server module 716 that the task has been performed (path 724). Mid-call control protocol server module 716 may then encode the message into a CSP confirmation and forward the CSP confirmation to CSP server module 714.

At mobility client 702, CSP client module 710 may receive the CSP confirmation from CSP server module 714 and forward the encoded CSP confirmation to mid-call control protocol client module 710. Upon receiving the CSP confirmation, mid-call control protocol client module 710 may decode the CSP confirmation and forward the message to call control client module 706. The message may then be forward to media server client module 726 to inform media server client module 726 of the switch, thereby enabling media server client module 726 to be ready to receive data packets from user B's telecommunication device.

Accordingly, each time user C wants to toggle between telecommunication sessions, the steps described in FIG. 7 is repeated. With the mid-call control protocol modules, a sub-channel is supported to enable the mobility server to communicate with the mobility client (e.g., telecommunication device or user C) in order to facilitate the multiple telecommunication sessions that may be active. As can be appreciated from the foregoing, the mid-call signaling channel may be maintained as long the mobility client is still participating in one of the telecommunication sessions. The mid-call signaling channel may be terminated when the single carrier connection is terminated, in an embodiment.

As can be appreciated from the forgoing, one or more embodiments of the present invention provide for an arrangement that supports multiple calls with a single carrier connection. With the mid-call signaling channel, mobility server is able to support multiple telecommunication sessions without having to rely upon the carrier networks to provide the service. Since only a single carrier connection is being established, a user may participate in a plurality of simultaneous calls without incurring a high cost for the service.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative was of implementing the methods and apparatuses of the present invention. It is therefore intended that the following appended claims be interpreted as including all such alterations, permutations, and equivalents as fall within the true spirit and scope of the present invention.

What is claimed is:

1. A method for enabling a first telecommunication device to conduct multiple simultaneous telecommunication sessions through a single carrier connection, comprising:
establishing a first telecommunication session using a mobility server between said first telecommunication device and a second telecommunication device, wherein said first telecommunication session including a first carrier connection between said first telecommunication device and said mobility server and a second carrier connection between said second telecommunication device and said mobility server;
establishing a mid-call signaling channel between said mobility server and said first telecommunication device, wherein said mid-call signaling channel being configured for at least handling interaction between said mobility server and said first telecommunication device while said first telecommunication device is connected through said first carrier connection;
utilizing said mid-call signaling channel to notify said first telecommunication device of an incoming telecommunication session request from a third telecommunication device; and
establishing a second telecommunication session using said mobility server between said first telecommunication device and said third telecommunication device, wherein said second telecommunication session including said first carrier connection between said first telecommunication device and said mobility server and a third carrier connection between said third telecommunication device and said mobility server.

2. The method of claim 1 wherein said handling interaction includes said mobility server managing at least one of incoming data traffic to and outgoing data traffic from said first telecommunication device.

3. The method of claim 2 further including employing said mid-call signaling channel to enable said first telecommunication device to toggle between said first telecommunication session and said second telecommunication session.

4. The method of claim 3 wherein said first telecommunication device sends a message to said mobility server to initiate said toggle, said message being a toggle request.

5. The method of claim 4 wherein activating said toggle includes
sending said toggle request via a call control client module of said first telecommunication device to a mid-call control protocol client module,
encoding said toggle request into a call signal protocol (CSP) notify message via said mid-call control protocol client module, and
sending said CSP notify message call via a CSP client module to said mobility server.

6. The method of claim 5 wherein said CSP notify message is sent via a network to said mobility server.

7. The method of claim 6 wherein receiving said CSP notify message by said mobility server includes
receiving said CSP notify message by a CSP server module,
sending said CSP notify message via said CSP server module to a mid-call control protocol server module,
decoding said CSP notify message via said mid-call control protocol server module into said toggle request,
receiving said toggle request by a call control server module,
notifying a media server module about said toggle request, and
performing said toggle request.

8. The method of claim 7 wherein said mobility server is configured for sending a confirmation to said first telecommunication device upon performing said toggle request, wherein said sending said confirmation includes
sending said confirmation via said call control server module to said mid-call control protocol server module,
encoding said confirmation by said mid-call control protocol server module into a CSP confirmation,
sending said CSP confirmation via said CSP server module to said CSP client module,
decoding said CSP confirmation into said confirmation via said mid-call control protocol client module,
sending said confirmation to said call control client module, and
notifying said media server client module about said confirmation.

9. The method of claim 8 wherein said mid-call control protocol client module is configured for interacting with said mid-call control protocol server module to support said mid-call signaling channel.

10. An arrangement for enabling a telecommunication device to conduct multiple simultaneous telecommunication sessions to be established through a single carrier connection, comprising:
a mobility server, said mobility server being configured to include at least a mid-call control protocol server module, wherein said mid-call control protocol server module being configured for at least interacting with a mid-call control protocol client module implemented in a mobility client of said telecommunication device to support a mid-call signaling channel, said mid-call signaling channel being configured for enabling said mobility client to conduct multiple simultaneous telecommunication sessions through said single carrier connection.

11. The arrangement of claim 10 wherein said mobility client sends a toggle request to said mobility server to toggle between said multiple simultaneous telecommunication sessions conducted through a single carrier connection.

12. The arrangement of claim 11 wherein said mobility client further includes
a call control client module, said call control client module being configured for at least sending said toggle request to said mid-call control protocol client module, and
a call signal protocol (CSP) client module, said CSP client module being configured for performing at least one of encoding said toggle request into a CSP notify message and sending said CSP notify message to said mobility server.

13. The arrangement of claim 12 wherein said mobility server further includes
a CSP server module, said CSP server module being configured for performing at least one of receiving said CSP notify message and decoding said CSP notify message into said toggle request,
a call control server module, said call control server module being configured for at least receiving said toggle request and sending a confirmation to said mobility client, and
a media server module, said media server module being configured for performing said toggle request upon receiving said toggle request from said call control server module.

14. An article of manufacture comprising a program storage medium having computer readable code embodied therein, said computer readable code being configured for enabling a first telecommunication device to conduct multiple simultaneous telecommunication sessions through a single carrier connection, comprising:
code for establishing a first telecommunication session using a mobility server between said first telecommunication device and a second telecommunication device, wherein said first telecommunication session including a first carrier connection between said first telecommunication device and said mobility server and a second carrier connection between said second telecommunication device and said mobility server;
code for establishing a mid-call signaling channel between said mobility server and said first telecommunication device, wherein said mid-call signaling channel being configured for at least handling interaction between said mobility server and said first telecommunication device while said first telecommunication device is connected through said first carrier connection;
code for utilizing said mid-call signaling channel to notify said first telecommunication device of an incoming telecommunication session request from a third telecommunication device; and
code for establishing a second telecommunication session using said mobility server between said first telecommunication device and said third telecommunication device, wherein said second telecommunication session including said first carrier connection between said first telecommunication device and said mobility server and a third carrier connection between said third telecommunication device and said mobility server.

15. The article of manufacturing of claim 14 further including code for employing said mid-call signaling channel to enable said first telecommunication device to toggle between said first telecommunication session and said second telecommunication session.

16. The article of manufacturing of claim 15 wherein said first telecommunication device sends a message to said mobility server to initiate said toggle, said message being a toggle request.

17. The article of manufacturing of claim 16 wherein code for activating said toggle includes
code for sending said toggle request via a call control client module of said first telecommunication device to a mid-call control protocol client module,
code for encoding said toggle request into a call signal protocol (CSP) notify message via said mid-call control protocol client module, and
code for sending said CSP notify message call via a CSP client module to said mobility server.

18. The article of manufacturing of claim 17 wherein said mobility server is configured for receiving said CSP notify message, said receiving includes
code for receiving said CSP notify message by a CSP server module,
code for sending said CSP notify message via said CSP server module to a mid-call control protocol server module,
code for decoding said CSP notify message via said mid-call control protocol server module into said toggle request,
code for receiving said toggle request by a call control server module,
code for notifying a media server module about said toggle request, and
code for performing the toggle request.

19. The article of manufacturing of claim 18 wherein said mobility server is configured for sending a confirmation to said first telecommunication device upon performing said toggle request, wherein said sending said confirmation includes
code for sending said confirmation via said call control server module to said mid-call control protocol server module,
code for encoding said confirmation by said mid-call control protocol server module into a CSP confirmation,
code for sending said CSP confirmation via said CSP server module to said CSP client module,
code for decoding said CSP confirmation into said confirmation via said mid-call control protocol client module,
code for sending said confirmation to said call control client module, and
code for notifying said media server client module about said confirmation.

20. The article of manufacturing of claim 19 wherein said mid-call control protocol client module includes code for interacting with said mid-call control protocol server module to support said mid-call signaling channel.
